(19) United States
(12) Patent Application Publication
(10) Pub. No.: US 2001/0037302 A1
(43) Pub. Date: Nov. 1, 2001

(54) Data web object host discovery system

(75) Inventors: David McFadzean, Calgary (CA); Kenneth Kittlitz, Calgary (CA); Sean Morgan, Calgary (CA)

Correspondence Address: BEYER WEAVER & THOMAS LLP, P.O. BOX 778, BERKELEY, CA, 94704-0778, US

(73) Assignee: Javien, Inc.

(21) Appl. No.: 09/840,848

(22) Filed: Apr. 23, 2001

Related U.S. Application Data
(60) Provisional application No. 60/208,682, filed on May 31, 2000.

(51) Int. Cl. G06F 17/60

(52) U.S. Cl. 705/51

(57) ABSTRACT

A system, method and apparatus for locating and accessing information resources in a distributed information network is disclosed. When an end user desires to retrieve an ID for a particular profile associated with a resource, a client program (resident on a client computer) sends a an ID request in the form of an HTTP request to an ID authority server computer. In response to the ID request, the ID authority server computer returns a URL of an ID registry server computer corresponding to the requested profile type. The client program then sends a query based upon the returned domain name to the ID registry server. The ID registry server, in turn, returns a URL of an ID host server computer associated with the requested ID so, in one implementation, the client can invoke a program that is a superset of the domain name. Once the client program has the location of the ID host server computer, the client program sends a request to the identified ID host server computer. The identified ID host server computer, in turn, responds by returning a list of all facets in a profile or, in some cases, one facet at a time.

### CROSS REFERENCE TO RELATED APPLICATIONS

This application claims benefit of priority under 35 U.S.C. 119(e) of U.S. Provisional Application No. 60/208682 (Att. Dkt. No. JAVNP001P) filed May 31, 2000 and entitled “JAVIEN DATAWEB OBJECT HOST DISCOVERY SYSTEM” by McFadzean, et al. which is incorporated by reference in its entirety.

### TECHNICAL FIELD

This invention relates generally to a method and apparatus for locating and accessing information resources in a distributed information network. Particularly, the present invention relates to a system and method for using a single access mechanism to search and view content from the Internet.

I. Introduction

The Internet includes a vast number of computers interconnected so that information can be exchanged amongst the computers. Various protocols and other interface standards have been developed for the Internet so that each computer will understand information from the other computers. The World-Wide Web (“WWW”, or the Web) is a subset of the Internet computers that support Hypertext Transfer Protocol (“HTTP”). HTTP is an application level protocol for distributed, collaborative, hypermedia information systems that defines the format and contents of messages and responses sent between client programs (“clients”) and server programs (“servers”) over the Internet. In addition, HTTP is a generic stateless, object oriented protocol which can be used for many other tasks, such as name servers and distributed object management systems, through various extensions.

The Web can be imagined to be an information space. Human beings are well equipped for manipulating, imagining, and finding their way in spaces. URIs are the points in that space. Uniform Resource Identifiers (URIs, are short strings that identify resources in the web: documents, images, downloadable files, services, electronic mailboxes, and other resources. They make resources available under a variety of naming schemes and access methods such as HTTP, FTP, and Internet mail addressable in the same simple way. They reduce the tedium of “log in to this server, then issue this magic command . . . ” down to a single click. The Internet facilitates information exchange between servers and clients that are located throughout the world. Each computer on the Internet has a unique address. When a client wishes to access a resource (e.g., a document), the client specifies a Uniform Resource Locator (“URL”) that uniquely identifies the computer on which the server executes and the resource. An example of a URL is “http://acme.com/page1”. In this example, the server is identified by “acme.com” and the resource is identified by “page1”. The URL has two parts: a schema and a schema specific part. The schema identifies the high level protocol through which the information is to be exchanged and the schema specific part contains additional information that identifies the server computer and the resource. The “http” at the beginning of the example URL is the schema and indicates that the remainder of the URL should be interpreted according to HTTP. The remainder specifies a server computer (i.e., “acme.com) followed by additional information that is specific to the server. For example, the additional information may be a path name within the server computer to a Hypertext Markup Language (“HTML”) document.

An HTTP URL can be for any Web page, not just a home page, or any individual file. For example, this URL would bring up the “whatis.com” logo image:

http://whatis.com/whatisAnim2.gif

A URL for a file meant to be downloaded would require that the “ftp” protocol be specified like this: ftp://www.somecompany.com/whitepapers/widgets.ps.

In the case of the URL, the user has to know where the resource is located as well as how to spell the file name and suffix. Unfortunately, however, the Uniform Resource Locator (URL) can change at the whim of hardware reconfiguration, file system reorganization, or changes in organizational structure. The unpredictable mobility of Internet resources is an inconvenience at best. For librarians and others, it is a serious problem that compromises their service to patrons and imposes an unacceptably large burden on catalog maintenance. A conventional approach to solving this problem is the development of the Uniform Resource Name (URNs).

A URN is an Internet resource with a name that has persistent significance that is, the user of the URN can expect that someone else (or a program) will be able to find the resource. A URN looks something like a Web page address or Uniform Resource Locator (URL). For example, here's a hypothetical URN:

urn:def://blue_laser

where “def://” might indicate an agency or an accessible directory of all dictionaries, glossaries, and encyclopedias on the Internet and “blue laser” was the name of a term. The result of using the agency could be the “best definition,” the “longest definition,” or even all definitions that the agency could find of “blue laser.”

A comparable URL would need to specify one specific location for a definition such as:

http://www.whatis.com/bluelase.htm

With a URN, the user only needs to know the name of a resource. One or more agencies will presumably be able to locate the nearest copy of the resource and the user is freed from understanding where resources are located or relocated to.

Unfortunately, however, even though URNs provide some measure of persistence, they still rely upon an updated directory to maintain the persistence of the URN and the resource. In those cases where the update is not performed, or performed slowly, or is performed incorrectly, the URN will not be able to link the client to the desired resource, with the usual result being “no document found”, or the equivalent thereof Therefore what is desired is a system and method by which a client can dynamically discover a particular resource given only a persistent and unique identifier.

### SUMMARY OF THE INVENTION

A system and method by which a client can dynamically discover a particular resource given only a persistent and unique identifier is disclosed.

In one embodiment, a computer based communication system for requesting and retrieving an information resource is described. The system includes a client computer arranged to generate an information resource request and an authority server coupled to the client computer arranged to provide a registry key to the client computer in response to the information resource request sent by the client computer to the authority server where the registry key is associated with the requested information resource. The system also includes a registry server coupled to the client computer identified by the registry key arranged to provide an information resource host computer location identifier, and an information resource host computer coupled to the client computer uniquely associated with the information resource host computer location identifier arranged to provide the requested information resource to the client computer.

In another embodiment, a computer based method of requesting and retrieving an information resource in a distributed computing system having a client computer, an authority server computer coupled to the client computer, a registry server computer coupled to the client computer, an information resource host computer coupled to the client computer is described. An information resource request is generated by the client computer that is sent by the client computer to the authority computer. The authority server computer provides a registry key associated with the requested information resource to the client computer in response to the information resource request. The registry key is sent to the registry server identified by the registry key by the client computer. An information resource host computer location identifier is provided by the registry server computer to the client computer in response to the sent registry key. The information resource request is sent to the requested information resource host computer corresponding to the information resource host computer location identifier. The requested information resource is forwarded to the client computer by the requested information resource host computer.

### BRIEF DESCRIPTION OF THE DRAWINGS

The invention, together with further advantages thereof, may best be understood by reference to the following description taken in conjunction with the accompanying drawings in which,

FIG. 1 shows an implementation of a profile in accordance with an embodiment of the invention;

FIG. 2 shows an exemplary profile used to describe a particular individual;

FIG. 3 is an example of one implementation of a DWID in accordance with an embodiment of the invention;

FIG. 4 shows a dataweb for discovering and retrieving a resource in accordance with an embodiment of the invention is shown;

FIG. 5 shows a flowchart is shown detailing a process for a client receiving a requested resource in accordance with an embodiment of the invention;

FIG. 6 shows a flowchart detailing an authentication process in accordance with an embodiment of the invention;

FIG. 7 shows a flowchart detailing an authentication process in accordance with an embodiment of the invention;

FIG. 8 shows a flowchart detailing a process that is one implementation of a permission matching operation in accordance with an embodiment of the invention;

FIG. 9 shows a flowchart detailing a process for retrieving a toll document in accordance with an embodiment of the invention;

FIG. 10 shows a flowchart detailing the process for paying for a toll facet in accordance with an embodiment of the invention.

FIG. 11 illustrates a computer system that can be employed to implement the present invention.

### DETAILED DESCRIPTION OF THE EMBODIMENTS

The following description is provided to enable any person skilled in the art to make and use the invention and sets forth the best modes contemplated by the inventor for carrying out the invention. Various modifications, however, will remain readily apparent to those skilled in the art, since the basic principles of the present invention have been defined herein specifically to provide a system and method by which a client can dynamically discover a particular resource given only a unique identifier.

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

Broadly speaking, an apparatus, system, and method for dynamically discovering a particular information resource given only a unique identifier are disclosed. In one embodiment, an object, referred to as a resource is associated with a profile. In the described embodiment, the resource can be either an online resource, such as a web page, digital image, MP3 file, etc., or an offline resource such as a person, restaurant, store, etc. A profile is a collection of information about the associated resource having a unique Internet Designator (ID). In a preferred embodiment, a profile has an associated type corresponding to a general description of the resource to which it is associated.

When implemented in a network using the HTTP protocol, such as the Internet, when an end user desires to retrieve an ID for a particular profile associated with a resource, a client program (resident on a client computer) sends a an ID request in the form of an HTTP request to an ID authority server computer. In response to the ID request, the ID authority server computer returns a URL of an ID registry server computer corresponding to the requested profile type. The client program then sends a query based upon the returned domain name to the ID registry server. The ID registry server, in turn, returns a URL of an ID host server computer associated with the requested ID so, in one implementation, the client can invoke a program that is a superset of the domain name. Once the client program has the location of the ID host server computer, the client program sends a request to the identified ID host server computer. The identified ID host server computer, in turn, responds by returning a list of all facets in a profile or, in some cases, one facet at a time. In the described embodiment, a facet is a logically related set of attributes pertaining to the resource being described that is typically included in the profile. In the described embodiment, only one client at a time can edit a particular facet requiring a “lease” for a specific time duration.

The invention will now be described in terms of a distributed network of computers (such as the Internet). It should be noted, however, that although the invention is described in terms of the Internet, any distributed network can be suitably employed to implement any desired embodiment of the invention. It should also be noted that although the invention will initially be described in terms of a multithreaded, object oriented computing system implemented using HTTP requests and responses, it should be noted that the present invention can be used in any system that is capable of handling well defined requests and responses across a distributed network.

Although any kind of data communications network and any kind of user interface can be used, the system can be constructed to work with existing Internet or World Wide Web protocols for data communications and display. In particular, the client program, for example, can be designed to use HyperText Markup Language (HTML) for display and editing. Standard Internet protocols for accessing the Web can also be used for accessing the information in the various registries. To do this, the client program is designed to emulate an HTTP server. Then any WEB browser program conforming to HTML/HTTP standards can generate Uniform Resource Locator (URL) requests to retrieve information from the various registries and databases. It should be noted that a WEB browser program is a set of instructions which causes the computer to execute information requests to servers, to receive, store, and display HTML data, data from servers in response to requests. Protocols other than HTML/HTTP can be used in the same manner, with an appropriate interface program for requesting, receiving, and displaying data in accordance with the selected protocols or formats.

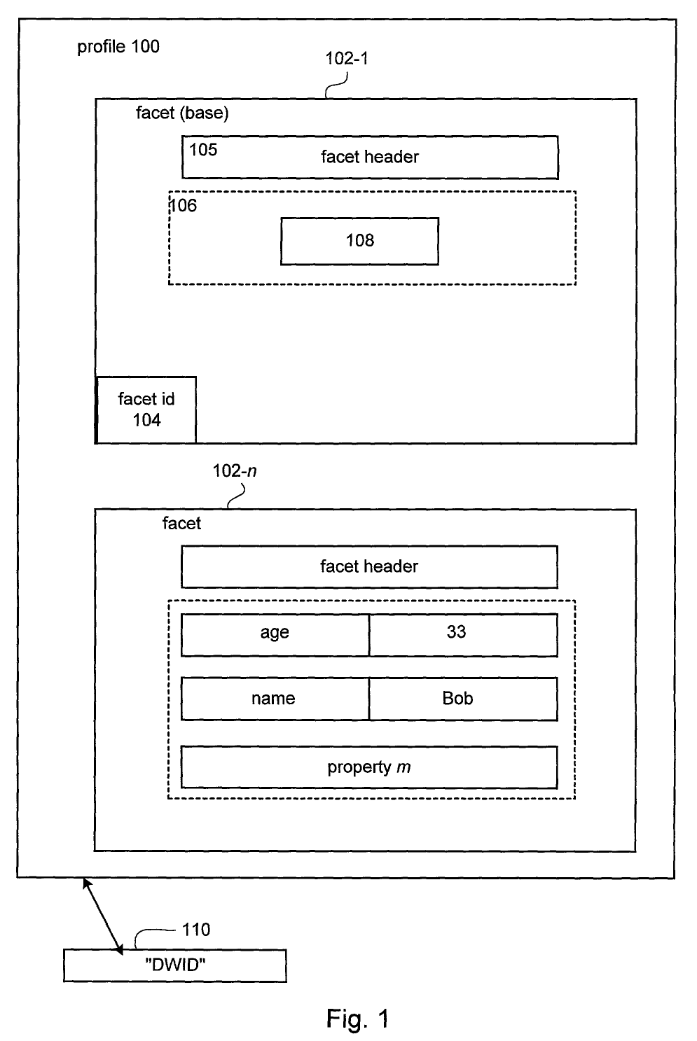

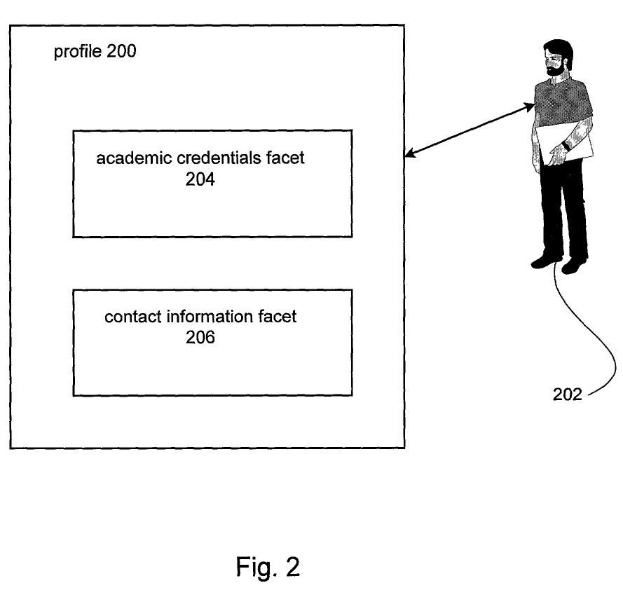

FIG. 1 shows a implementation of a profile 100 in accordance with an embodiment of the invention. As described earlier, a profile is a collection of information about a particular resource that can be, for example, an online resource (such as a webpage or HTML document) or an offline resource (such as a restaurant or an individual). The profile 100, therefore, includes any number of facets 102. In the described embodiment, a facet is a logically related set of attributes pertaining to the resource being described by the profile 100. In the described embodiment, an attribute is name-value pair that represents a particular property, characteristic, or other such indicia. For example, in FIG. 2, a profile 200 is used to describe a particular individual 202. In this example, the profile 200 includes an academic credentials facet 204 that contains information related to the academic credentials of the individual 202 and a contact information facet 206 that contains contact information for the individual 202.

Referring back to FIG. 1, the profile 100 includes a base facet 102-1 identified by a facet ID 104. As implemented, the base facet 102-1 is used to describe basic information typically used to identify the resource associated with the profile 100. Such basic information is typically stored in a facet header 105 that includes, for example, a facet name, a facet create date, a facet update date, a facet security level, a facet permission list, a face status flag, and a facet class indicator, amongst others. In addition to the facet header 105, the facet 102-1 (as well as any other facets that happen to be included in the profile 100) includes a facet body 106 that is configured to include a hierarchical collection of properties 108 descriptive of the associated resource. Typically, a property is a key-value pair where, in one implementation, both the key and the value are text strings such as (“age”, “33”), or (“name”, “Bob”). In one embodiment, the value portion of the property can be a literal string, or in some cases a pointer to another property, an ID that references another profile, or even a facet within a particular profile. In this way, the hierarchical organization of the facet 102 provides great flexibility in linking and cross linking various resources, profiles, facets, and properties.

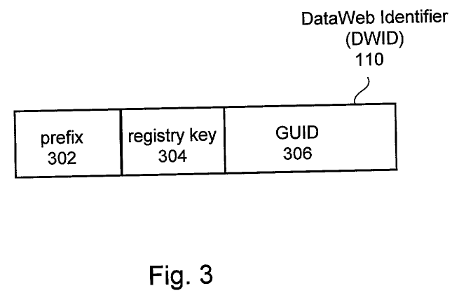

In the described embodiment, each profile is uniquely identified by what is referred to as a DataWeb Internet Designator (DWID) 110. FIG. 3 is an example of one implementation of the DWID 110 in accordance with an embodiment of the invention. The DWID 110 is a string that acts as a unique identifier for the profile 100. As presently configured, the DWID 110 includes a prefix portion 302 (typically in the form of a identifier tag: “id”), a registry key field 304, and a globally-unique identifier (GUID) 306 (described in more detail below). In the described embodiment, the registry key field 304 designates the type of resource associated with the particular DWID. For example, the type field 304 can designate that the DWID 110 is associated with an agent or, for example, a schema.

An example of a valid DWID is

“id:agent:621AE67-F7F2-4c34-202-e686415574B” indicating that the resource associated with the corresponding DWID is an agent type resource uniquely identified by the associated GUID.

It should be noted that an agent is a particular type of resource that, in particular, is the only type of resource that can own a profile (as identified in the base facet as owner). Examples of an agent include, a person, organization, or an autonomous software program that represents another entity (such as a person or organization). In the parlance of the invention, the latter example of an agent is generally referred to as a proxy, or proxy agent. It should also be noted that a schema is generally defined to be a profile that includes metadata about facets. For example, every facet header includes a schema ID that points to, or otherwise identifies, a schema that describes the format of the particular facet body.

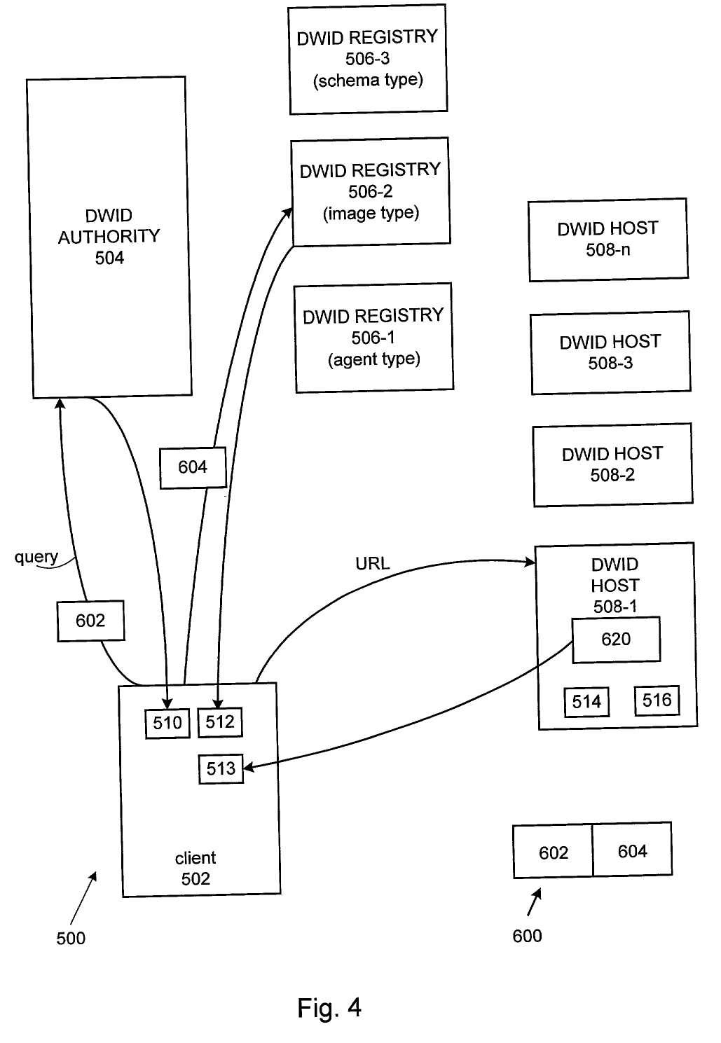

Turning now to FIG. 4, a dataweb 500 for discovering and retrieving an information resource in accordance with an embodiment of the invention is shown. The dataweb 500 includes a client 502 coupled to a DWID authority server 504, a number of DWID registry servers 506-1 through 506-3, and a number of DWID host servers 508-1 through 508-n. In the described embodiment, the DWID authority server 504 provides a service for mapping a registry key to a particular one of the DWID registry servers 506-1 through 506-3. For example, if a particular DWID is an agent type DWID, then the DWID authority server 504 maps the agent type DWID to, for example, the DWID registry server 506-1 (and conversely, maps an image type DWID to the DWID registry server 506-2 and a schema type DWID to the DWID registry server 506-3. It should be noted, therefore, that there are as many DWID registry servers as there are DWID types, or more generally, a registry service is provided for every DWID type. In some cases, a particular server (such as 506-2) can have any number of registry services provided therein such that the DWID authority 504 then maps various DWID types to virtual memory locations within the physical embodiment of the DWID server 506-2 as opposed to individual servers.

In the described embodiment, each of the DWID host servers 508-1 through 508-n provides a service to store profiles according to their respective DWIDs. In addition to storing the various profiles, the DWID host servers 508 will typically have facilities for profile management such as creating a new profile, editing existing profiles, as well as publishing a selected facet (or facets) of profiles to the dataweb 500.

For example, in order to resolve a DWID 600 into the location of its associated resource 620, a query is sent by the client 502 to the DWID authority 504 requesting the location of the DWID registry server corresponding to the particular profile type associated with the requested DWID (also referred to as a DWID_{content}). Typically, the query takes the form of a HTTP request when the dataweb 500 is an http type distributed network of computers. In one implementation, the client parses the DWID 600 into a type field 602 and a GUID field 604. In this example, the type field 602 indicates that the resource to be located is an image type resource (such as a JPG, GIF or TIFF file, for example) having a unique GUID corresponding to the GUID field 604. It should be noted that in those situations where bandwidth is to be preserved, the client 502 can be configured to only send a fragment of the DWID. For example, in order to preserve bandwidth, the client 502 can decide to only send the registry key field 602 to the DWID authority 504 since the DWID authority 504 is only interested in resolving the location of the DWID registry server associated with the particular DWID type (i.e., image in this example).

The DWID authority 504 responds to the client's query by providing the location of the DWID registry (506-2 in this case) that corresponds to the requested DWID type (image). In a preferred embodiment, the client 502 has a cache memory 510 that is used to store the returned DWID registry location thereby reducing subsequent retrieval times as well as reducing the number of transactions that are required to be sent to the DWID authority 504. Subsequent to the receiving of the location of the desired DWID registry, the client 502 sends a request to the identified DWID registry server requesting the location of the DWID host in which the desired resource (i.e., image) is stored based upon the GUID associated with the profile associated with the stored image. Again, in a preferred embodiment, in order to reduce system bandwidth and improve overall system performance, the location of the DWID host corresponding to the GUID 604 is stored in a cache memory 512 for later retrieval when the GUID 604 is again encountered by the client 502. This is one of the advantages afforded by the invention since the GUID 604 is permanently assigned to the resource 620 (unless affirmatively deleted or otherwise intentionally modified).

Once the client 502 has received the DWID host location (for example, the DWID host server 508-1) that is storing the requested resource 620, the client 502 sends a request (which in this case can be a conventional URL type request since the location of the resource to be retrieved is now known with assurity) to the identified DWID host computer. The DWID host computer 508-1, in turn, responds to the client request and provides the requested aspect of the particular resource's profile. Again, in order to reduce subsequent downloads and thereby reduce bandwidth, the requested resource in the form of its associated facet can be stored locally in a cache memory 513.

In some embodiments, prior to the downloading of the selected resource, the DWID host server 508-1 can provide in addition to the profile management and storage services, an authentication service 514 and an authorization service 516. In this way, any requestor can be authenticated by the DWID host server and once authenticated, a determination of the proper authorization can be made. Typically, a facet will include as part of its constituent properties a permission list of those DWIDs for which a designated permission is granted. For example, a particular resource can have a profile that indicates only a certain group of requestors (in the form of their respective DWIDs) can have access to the resource. Once access is granted selected ones of the certain group of requestors have a read only permission with regards to the resource. In some cases, requestors can be charged for the privilege of either downloading or viewing (in the case of an image type resource) the resource.

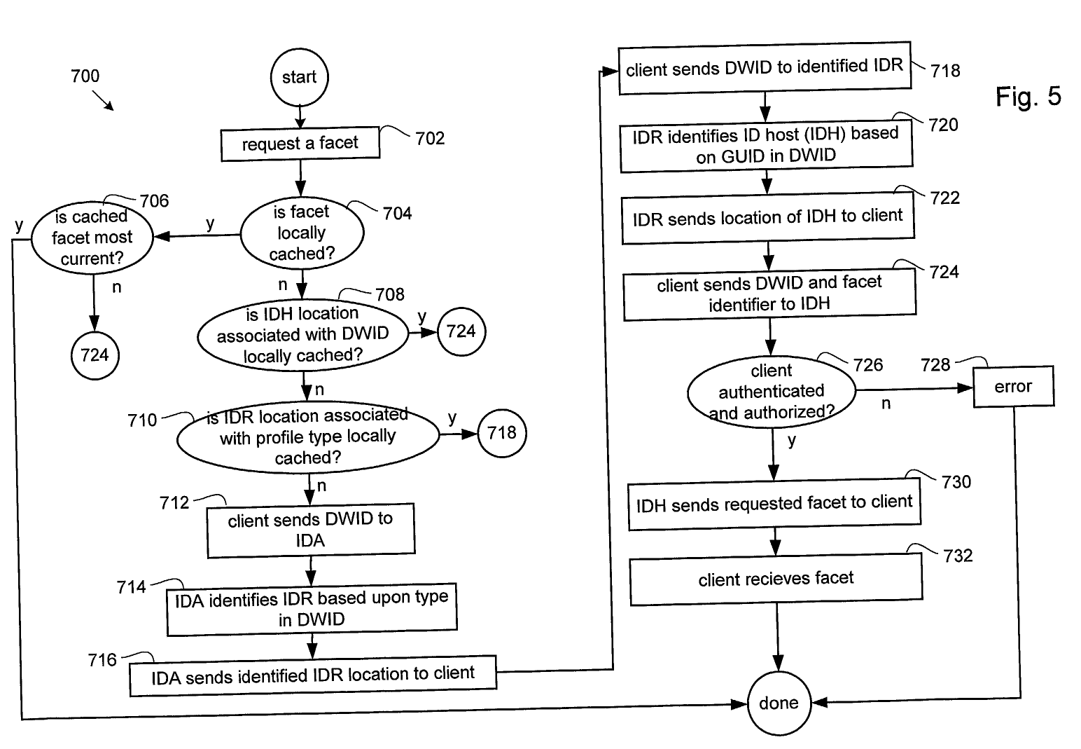

Turning now to FIG. 5, a flowchart is shown detailing a process 700 for a client receiving a requested resource (in the form of an associated facet) in accordance with an embodiment of the invention. The process 700 begins at 702 by the client requesting a particular facet indicated by its associated DWID (referred to as DWID_{content}). A determination is then made at 704 whether or not the requested facet is locally cached. If the requested facet is locally cached, then a determination is made at 706 whether or not the locally cached facet is the most current facet. If the locally cached facet is the most current facet, then the process 700 stops, otherwise control is passed to 724. Returning to 704, if it was determined that the requested facet was not locally cached, then a determination is made at 708 whether or not the location of the DWID host associated with the DWID_{content} is locally cached. If it is determined that the location of the DWID host associated with the DWID_{content} is locally cached, then control is passed to 724, otherwise a determination is made at 710 whether or not the location of the DWID registry associated with the profile type corresponding to the DWID_{content} is locally cached. If it is determined that the location of the DWID registry associated with the profile type corresponding to the DWID_{content} is locally cached, then control is passed to 718, otherwise, the client sends the DWID_{content} to the DWID authority at 712. In a preferred embodiment, the client sends just the type field of the DWID_{content} to the DWID authority in order to preserve bandwidth.

In the described embodiment, the DWID authority identifies the DWID registry based upon the type field associated with the DWID_{content} at 714 and sends the identified DWID registry location to the client at 716. At 718, the client sends the DWID_{content} to the identified DWID registry which, in turn, identifies the DWID host at 720 based upon the GUID associated with the DWID_{content}. At 722, the DWID registry sends the location of the identified DWID host to the client which, in turn, sends the DWID_{content} and a facet identifier (which uniquely identifies a profile and is included therein) at 724. At 726, a determination is made whether or not the client is authenticated and authorized. If the client is not both authenticated and authorized, then an error is thrown at 728, otherwise the DWID host sends the requested facet to the client at 730. At 732, the client receives the facet.

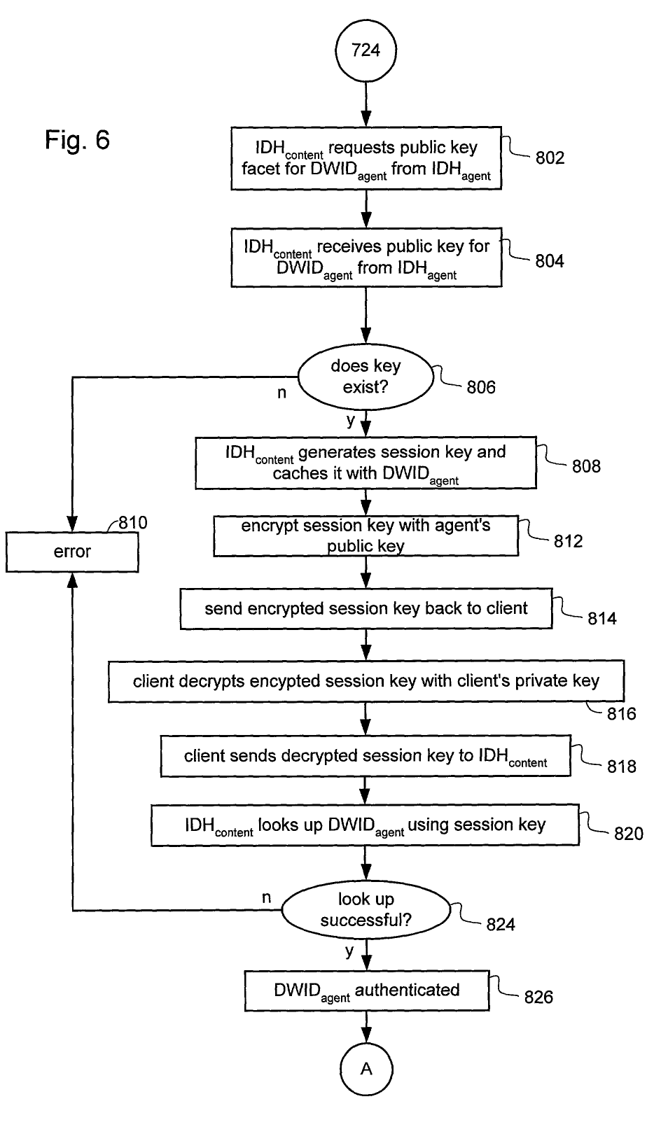

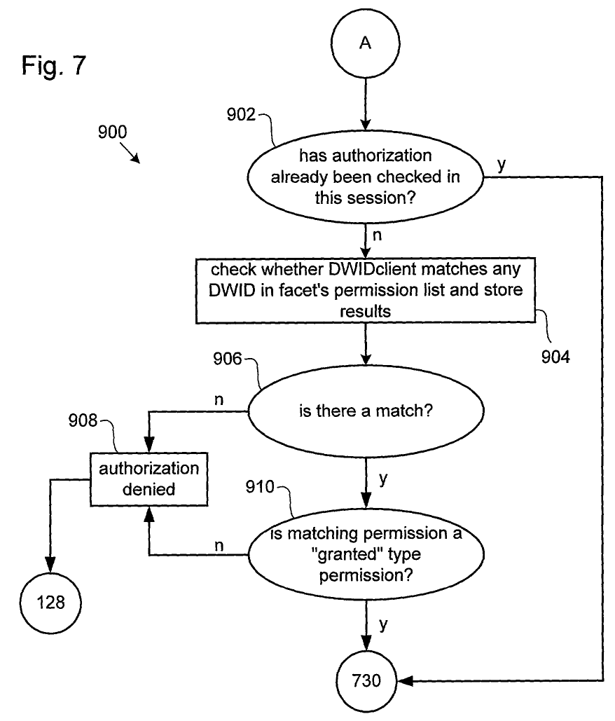

FIG. 6 shows a flowchart detailing an authentication process 800 used to implement operation 726 in accordance with an embodiment of the invention. It should be noted that the process 800 is but an example of the operation 726 and is therefore not intended to limit either the scope or the breadth of the invention. The process 800 begins at 802 by the DWID Host associated with the content (DWIDH_{content}) requesting a public key facet for the DWID_{agent} (i.e., the ID host for the agent's ID) from the DWID host associated with the client (DWID_{agent}). At 804, the DWIDcontent receives the public key for the DWID_{agent} from the DWIDH_{agent}. At 806, a determination is made whether or not the key exists. If the key does not exist, then control is passed to 210 where an error flagged, otherwise, the DWID_{content} generates a session key and caches it with the DWID_{agent} at 808. At 812, the session key is encrypted with the DWID_{agent}'s public key and at 814, the encrypted session key is sent back to the client. The client, in turn, decrypts the encrypted session key with the client's private key at 816 and at 818, the client sends the decrypted session key to the DWID_{content}. At 820, the DWID_{content} looks up the DWID_{agent} using the session key and at 822 a determination is made whether or not the look up was successful. If the lookup was not successful, then an error flag is thrown at 810, otherwise the DWID_{agent} is authenticated at 826 after which DWID_{agent} is to be authorized as detailed by the flowchart shown in FIG. 7.

FIG. 7 shows a flowchart detailing an authentication process 900 used to implement operation 726 in accordance with an embodiment of the invention. It should be noted that the process 900 is but an example of the operation 726 and is therefore not intended to limit either the scope or the breadth of the invention. The process 900 begins at 902 by a determination whether or not the authorization has already been checked for this particular session. If the authorization has been checked and the DWID_{agent} is authorized, then control is passed to 730, otherwise a check is performed at 904 whether the DWID_{client} matches any DWID in the facet's permission list and the result is stored. At 906, a determination is made whether or not there is match. If it is determined that a match has not occurred, then authorization is denied at 908, otherwise a determination is made at 910 whether the matching permission is a granted type permission. If the matching permission is not a granted type permission, then authorization is denied at 908, otherwise control is passed to 730.

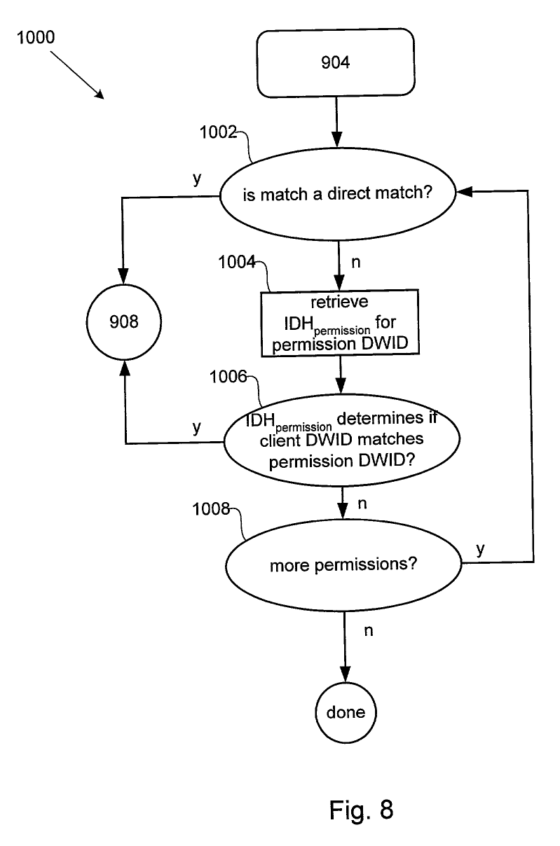

FIG. 8 shows a flowchart detailing a process 1000 that is one implementation of the matching operation 904 in accordance with an embodiment of the invention. It should be noted that the process 1000 is but an example of the operation 904 and is therefore not intended to limit either the scope or the breadth of the invention. The process 1000 begins at 1002 by determining whether the match is a direct match. It should be noted that as implemented in the described embodiment, a direct match is a direct string comparison of the identifiers being compared. If the match is a direct match then control is passed to 906, otherwise, the DWIDHₚₑᵣₘᵢₛₛᵢₒₙ is retrieved for the permission DWID at 1004 and at 1006, a determination is made whether or not the DWIDHₚₑᵣₘᵢₛₛᵢₒₙ matches the permission DWID. IF the DWIDHₚₑᵣₘᵢₛₛᵢₒₙ matches the permission DWID, then control is passed to 906, otherwise a determination is made at 1008 whether or not there are additional permissions. If there are additional permissions, then control is passed back to 1002, otherwise the process 1000 is complete.

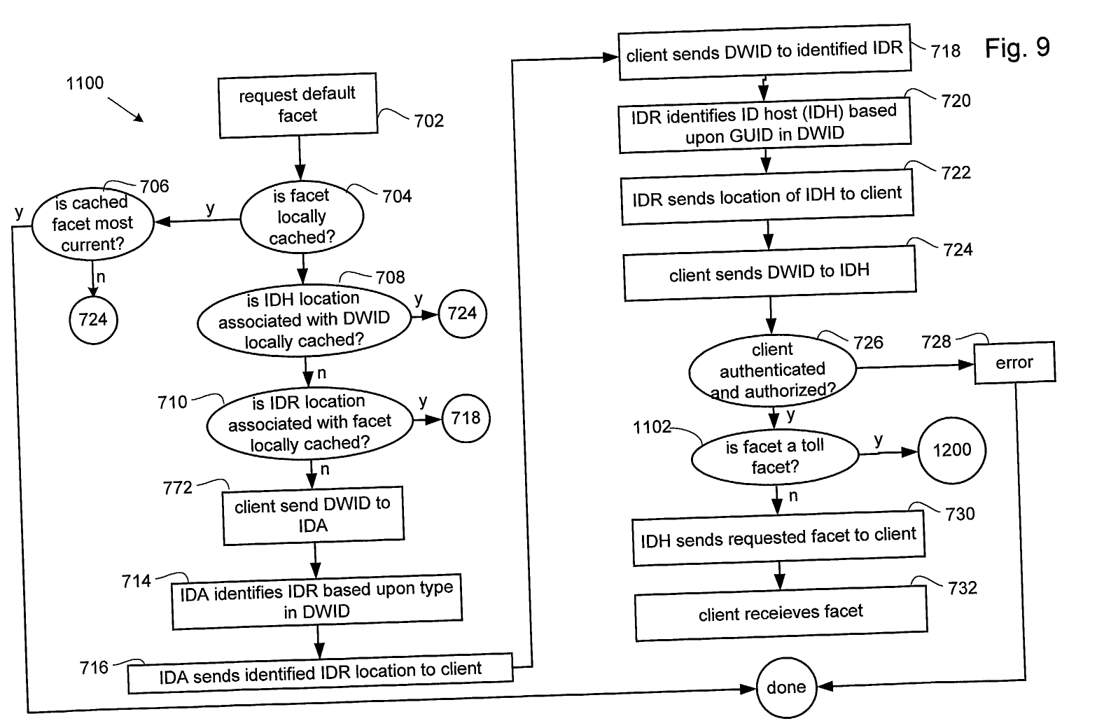

In some cases, the resource being requested is what is referred to as a toll document wherein the requestor must pay a fee for the document. This is typical of copyrighted material, such as books and music. With this in mind, FIG. 9 shows a flowchart detailing a process 1100 for retrieving a toll document in accordance with an embodiment of the invention. It should be noted that for sake of brevity only, the process 1100 is described in terms of the process 700 whereby an additional determination 1102 is made subsequent to the successful authorization and authentication 726. Therefore, once the client has been successfully authenticated and authorized, a determination is made at 1102 whether or not the facet is a toll facet. If the facet is not a toll facet, then control is passed to 730, otherwise, control is passed to a process 1200 described below.

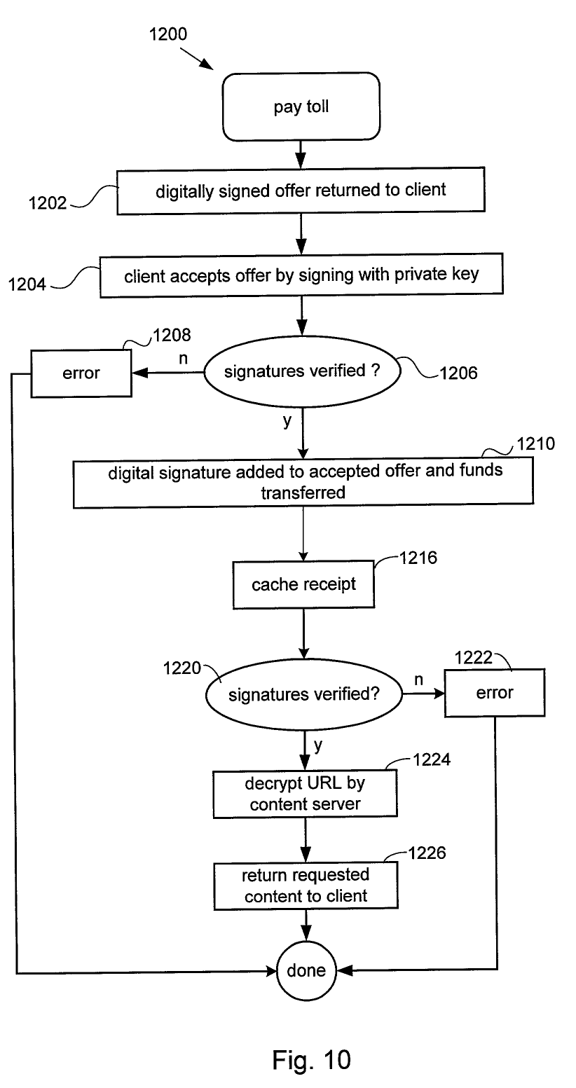

FIG. 10 shows a flowchart detailing the process 1200 for paying for a toll facet in accordance with an embodiment of the invention. The process 1200 begins at 1202 by a digitally signed offer being returned to the client. At 1204, the client accepts the offer by signing with a private key. In the described embodiment, the client forwards the signed offer to a transaction server having an associated transaction server signature. At 1206, a verification of the client's signature and the transaction server signature is made. If the either signature is not verified, then an error is thrown at 1208, otherwise the offer is accepted at 1210 (resulting in finds being transferred and a receipt being generated and returned to the client). After the offer has been appropriately accepted, a receipt is cached at 1216. The signatures are verified at 1220. If the signatures are not verified, then control is pass to 1222, otherwise the URL is decrypted by the content server 1224 and the requested content is returned to the client at 1226.

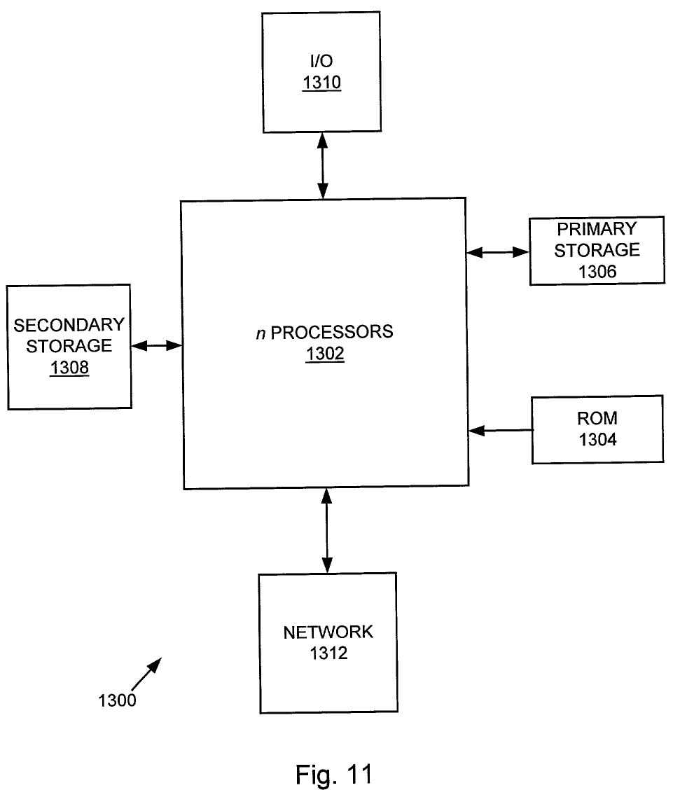

FIG. 11 illustrates a computer system 1300 that can be employed to implement the present invention. The computer system 1300 or, more specifically, CPUs 1302, may be arranged to support a virtual machine, as will be appreciated by those skilled in the art. As is well known in the art, ROM acts to transfer data and instructions uni-directionally to the CPUs 1302, while RAM is used typically to transfer data and instructions in a bi-directional manner. CPUs 1302 may generally include any number of processors. Both primary storage devices 1304, 1306 may include any suitable computer-readable media. A secondary storage medium 1308, which is typically a mass memory device, is also coupled bi-directionally to CPUs 1302 and provides additional data storage capacity. The mass memory device 1308 is a computer-readable medium that may be used to store programs including computer code, data, and the like. Typically, mass memory device 1308 is a storage medium such as a hard disk or a tape which generally slower than primary storage devices 1304, 1306. Mass memory storage device 1308 may take the form of a magnetic or paper tape reader or some other well-known device. It will be appreciated that the information retained within the mass memory device 1308, may, in appropriate cases, be incorporated in standard fashion as part of RAM 1306 as virtual memory. A specific primary storage device 1304 such as a CD-ROM may also pass data uni-directionally to the CPUs 1302.

CPUs 1302 are also coupled to one or more input/output devices that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPUs 1302 optionally may be coupled to a computer or telecommunications network, e.g., an Internet network or an intranet network, using a network connection. With such a network connection, it is contemplated that the CPUs 1302 might receive information from the network, or might output information to the network in the course of performing the above-described method steps. Such information, which is often represented as a sequence of instructions to be executed using CPUs 1302, may be received from and outputted to the network, for example, in the form of a computer data signal embodied in a carrier wave. The above-described devices and materials will be familiar to those of skill in the computer hardware and software arts.

Although only a few embodiments of the present invention have been described, it should be understood that the present invention may be embodied in many other specific forms without departing from the spirit or the scope of the present invention.

Although the methods of providing efficient techniques for identifying content in accordance with the present invention are suitable for implementation with personal computers, digital assistants, and the like, the methods may generally be applied in any suitable low bandwidth or high bandwidth distributed data network. In particular, the methods are suitable for use in digital appliances and other low bandwidth networks. Such low bandwidth systems include, but are not limited to: virtual private networks direct serial connections across telephone lines (“BBS systems”), and LANs and WANs regardless of network protocol.

While the present invention has been described as being used with a computer system coupled to the Internet, it should be appreciated that the present invention may generally be implemented on any suitable computer system. Therefore, the present examples are to be considered as illustrative and not restrictive, and the invention is not to be limited to the details given herein, but may be modified within the scope of the appended claims along with their full scope of equivalents.

What is claimed is:

1. A computer based communication system for requesting and retrieving an information resource, comprising:
a client computer arranged to generate an information resource request;
an authority server coupled to the client computer arranged to provide a registry key to the client computer in response to the information resource request sent by the client computer to the authority server, wherein the registry key is associated with the requested information resource;
a registry server coupled to the client computer identified by the registry key arranged to provide an information resource host computer location identifier; and
an information resource host computer coupled to the client computer uniquely associated with the information resource host computer location identifier arranged to provide the requested information resource to the client computer.

2. A communication system as recited in claim 1, wherein the information resource is associated with a resource profile.

3. A communication system as recited in claim 2, wherein the profile includes a facet associated with and used to identify a property of the information resource.

4. A communication system as recited in claim 3, wherein the information resource request includes an identifier (ID).

5. A communication system as recited in claim 4, wherein the identifier is a string that is uniquely associated with the profile.

6. A communication system as recited in claim 5, wherein the identifier includes,
a prefix portion,
a registry key field used to store the registry key, and
a globally-unique identifier (GUID).

7. A communication system as recited in claim 6, wherein the registry key field designates a resource type associated with the particular identifier.

8. A communication system as recited in claim 7, wherein the resource type is selected from a group comprising: an agent type resource, a schema type resource, and an image type resource.

9. A communication system as recited in claim 8, wherein the agent type resource that can own a particular profile, wherein the agent type resource is identified as the profile owner in a base facet of the particular profile.

10. A communication system as recited in claim 9, wherein the agent type resource is selected from a group comprising:, a person, an organization, and a proxy agent, wherein the proxy agent is an autonomous software program that represents another entity.

11. A communication system as recited in claim 10 further comprising:
a first cache memory locally coupled to the client computer arranged to store a facet;
a second cache memory locally coupled to the client computer arranged to store information resource host computer location identifier; and
a third cache memory locally coupled to the client computer arranged to store the registry key.

12. A communication system as recited in claim 11, wherein the information resource request that is sent by the client computer to the authority server is the registry key associated with the requested information resource.

13. A communication system as recited in claim 12, wherein the authority server responds to the registry key by providing the location of the information resource host computer to the client computer.

14. A communication system as recited in claim 13, wherein the client computer forwards a URL to the information resource host computer.

15. A communication system as recited in claim 14, wherein the information resource host computer responds to the URL by providing the requested information resource.

16. A communication system as recited in claim 15, wherein when the first cache memory includes the requested information resource host computer location identifier, then the client computer sends the information resource request and a facet identifier directly to the information resource host computer corresponding to the cached requested information resource host computer location identifier.

17. A communication system as recited in claim 16, wherein when the second cache memory includes a registry server location corresponding to the registry key associated with the requested information resource, then the client computer sends the information resource request directly to the registry server corresponding to he cached registry key.

18. A communication system as recited in claim 17, wherein when the client computer is not authorized and authenticated, then the information resource request is denied by the requested information resource host computer.

19. A computer based method of requesting and retrieving an information resource in a distributed computing system having a client computer, an authority server computer coupled to the client computer, a registry server computer coupled to the client computer, an information resource host computer coupled to the client computer, comprising:
generating an information resource request by the client computer;
sending the information resource request by the client computer to the authority computer;
providing a registry key associated with the requested information resource to the client computer in response to the information resource request by the authority server;
sending the registry key to the registry server identified by the registry key by the client computer;
providing an information resource host computer location identifier by the registry server computer to the client computer in response to the sent registry key; and
sending the information resource request to the requested information resource host computer corresponding to the information resource host computer location identifier; and
providing the requested information resource to the client computer by the requested information resource host computer.

20. A communication system as recited in claim 19, wherein the information resource is associated with a resource profile.

21. A communication system as recited in claim 20, wherein the profile includes a facet associated with and used to identify a property of the information resource.

22. A communication system as recited in claim 21, wherein the information resource request includes an identifier (ID).

23. A communication system as recited in claim 22, wherein the identifier is a string that is uniquely associated with the profile.

24. A communication system as recited in claim 23, wherein the identifier includes,
a prefix portion,
a registry key field used to store the registry key, and
a globally-unique identifier (GUID).

25. A communication system as recited in claim 24, wherein the registry key field designates a resource type associated with the particular identifier.

26. A communication system as recited in claim 25, wherein the resource type is selected from a group comprising: an agent type resource, a schema type resource, and an image type resource.

27. A communication system as recited in claim 26, wherein the agent type resource that can own a particular profile, wherein the agent type resource is identified as the profile owner in a base facet of the particular profile.

28. A communication system as recited in claim 27, wherein the agent type resource is selected from a group comprising: a person, an organization, and a proxy agent, wherein the proxy agent is an autonomous software program that represents another entity.

29. A communication system as recited in claim 28 further comprising:
coupling a first cache memory locally to the client computer arranged to store a facet;
coupling a second cache memory locally to the client computer arranged to store information resource host computer location identifier; and
coupling a third cache memory locally to the client computer arranged to store the registry key.

30. A communication system as recited in claim 29, wherein when the first cache memory includes the requested information resource host computer location identifier, then
sending the information resource request and a facet identifier directly to the information resource host computer corresponding to the cached requested information resource host computer location identifier.

31. A communication system as recited in claim 30, wherein when the second cache memory includes a registry server location corresponding to the registry key associated with the requested information resource, then
sending the information resource request directly to the registry server corresponding to he cached registry key.

32. A communication system as recited in claim 30, wherein when the client computer is not authorized and authenticated, then
denying the information resource request by the requested information resource host computer.

33. A method of paying a toll associated with a resource, comprising:
requesting a default facet associated with the resource;
retrieving the requested default facet;
determining if the retrieved default facet is a toll facet;
if the default facet is a toll facet, then
generating a verified offer for the toll facet; and
returning the requested resource based upon the verified offer.

34. A method as recited in claim 33, wherein the generating a verified offer comprises:
returning a digitally signed offer;
accepting the digitally signed offer;
verifying a digital signature corresponding to digitally signed offer;
adding verified digital signature to accepted offer; and
transferring funds based upon verified digital signature.

35. A method as recited in claim 33, wherein the generating a verified offer further comprises:
cacheing a receipt associated with the accepted offer;
verifying the digital signature; and
decrypting a resource identifier associated with the requested resource.

36. A method as recited in claim 33, wherein the accepting comprises:
signing the digitally signed offer with a private key.

37. A method as recited in claim 33, wherein the resource identifier is a URL.

38. An apparatus for paying a toll associated with a resource, comprising:
a means for requesting a default facet associated with the resource;
a means for retrieving the requested default facet;
a means for determining if the retrieved default facet is a toll facet;
a means for generating a verified offer for the toll facet; and
a means for returning the requested resource based upon the verified offer.

39. An apparatus as recited in claim 38, wherein the generating a verified offer comprises:
a means for returning a digitally signed offer;
a means for accepting the digitally signed offer;
a means for verifying a digital signature corresponding to digitally signed offer;
a means for adding verified digital signature to accepted offer; and
a means for transferring funds based upon verified digital signature.

40. An apparatus as recited in claim 38, wherein the generating a verified offer further comprises:
a means for cacheing a receipt associated with the accepted offer;
a means for verifying the digital signature; and
a means for decrypting a resource identifier associated with the requested resource.

41. An apparatus as recited in claim 39, wherein the accepting comprises:
a means for signing the digitally signed offer with a private key.

42. An apparatus as recited in claim 38, wherein the resource identifier is a URL.
